(19) United States
(12) Patent Application Publication
(10) Pub. No.: US 2002/0130900 A1
(43) Pub. Date: Sep. 19, 2002

(54) System for generating an interface for software applications in a client-server environment

(75) Inventor: Keir Brandon Davis, Greensboro, NC (US)

Correspondence Address: Kimberly B. Gatling, Smith Helms Mulliss & Moore, L.L.P., P.O. Box 21927, Greensboro, NC, 27420, US

(73) Assignee: Tomorrowsoft Corporation

(21) Appl. No.: 09/810,018

(22) Filed: Mar. 16, 2001

(51) Int. Cl. G06F 13/00

(52) U.S. Cl. 345/744; 345/745

(57) ABSTRACT

A system for generating an interface for a software application in a client-server environment. A projector runs on a server computer and processes a software application having an interface component and a code component. A thin client program called a viewer runs on a client computer that remotely accesses the software application on the projector. The projector transmits to the viewer only the interface component of the software application. The interface component includes information about all the widgets needed to execute the application, such as their placement, size, and captions. The viewer renders the graphical user interface with the native widget set of the client computer's operating system, based on the widget information from the projector. Therefore, the native widget set dictates the appearance of the widgets, such as their style and shape, and the interface for the application looks and feels like a native desktop application.

### BACKGROUND OF THE INVENTION

The present invention relates to software applications in client-server environments, and more particularly, to a system for generating an interface for software applications in accordance with the desktop interface of the client computer.

A “thin client” in a client-server environment is one that performs very little data processing. The server performs most application processing and the client computer processes user input and output. Current thin-client technologies generally fall into two categories: internet browser-based applications and custom client binary applications.

A current trend in software development is the creation of browser-based thin clients using programming languages such as Java. These programs, however, are slow and wrought with cross-platform problems due to incompatibilities in the way internet browsers render hypertext markup language (“HTML”) and implement Java virtual machines. Microsoft Corporation has proposed several programming solutions, such as SOAP® and C#® to make it easier to provide thin-client applications through an internet browser. However, such programs are directed to client computers using Microsoft's Internet Explorer® and server computers using Microsoft's operating system. With today's server and client market becoming more heterogeneous with systems such as Windows, Linux, and Palm Pilots, etc., this approach is somewhat limited.

Portal applications fall into the category of browser-based applications and tend to use Java client programs spawned by the client's browser. In general, the performance of these clients is poor and they tend to suffer from compatibility problems between Java virtual machines. Another drawback of portal applications is that they appear in special Java windows created by the browser. This limits the control a software application developer has in window placement and style, etc. Frequently, the style of the widgets (windows, menus, buttons, text boxes, scroll bars, etc.) inside the window do not match the window style itself and the window does not integrate with the user's desktop.

The second category of thin clients, custom client binaries, sends screen shots of the application running on the server to the client. Examples of such applications include Citrix's WinFrame® client, Microsoft's Terminal Server® client, and Symantec's pcAnywhere®. These applications all employ a similar method of sending bitmapped screen updates to a viewer on the client. While these programs have become quite sophisticated, they still feel sluggish to a user. In addition, these programs force the user to use applications that have the look and feel of the server. They also tend to run within a single viewer window that doesn't integrate well with the user's local desktop.

Accordingly, there is a need in the art for a client-server system that generates an interface for software applications in accordance with the desktop interface on the client computer, rather than the interface on the server. Further, there is a need in the art for a client-server system including a thin client program that is fast and easily compatible across multiple platforms.

### SUMMARY OF THE INVENTION

The present invention provides a system for generating a graphical user interface for a software application in a client-server environment comprising a projector that runs on a server computer, the projector being configured to process a software application having an interface component and a code component, and a viewer that runs on a client computer, the viewer being configured to generate a graphical user interface for the software application. The projector provides the viewer with the interface component of the software application, the interface component including information about at least one widget of the software application. The information about the at least one widget is stored on the client computer, and the viewer renders the graphical user interface on the client computer with a native widget set of the client computer based on the information about the at least one widget stored on the client computer.

During execution of the software application by the client computer, the projector directs the viewer to update the graphical user interface with the native widget set of the client computer based on the information about the at least one widget stored on the client computer. Also during execution of the software application, the code component of the application is processed in the projector, which is a software application server. Preferably, the code processing is performed in a virtual machine within the projector.

In a preferred embodiment, the server computer comprises application storage for storing the software application. Preferably, the interface component and the code component of the software application are stored as a single file. The software application is published on the projector when the interface component and the code component of the software application are stored in the server computer and handler code in the interface component is translated to byte code. The software application is accessible to the client computer once the software application is published on the projector.

The viewer is a thin client program, and is preferably portable across a plurality of operating systems such as Microsoft's Windows and Linux. The projector provides the viewer with the interface component of the software application in a descriptive language, such as Extensible Markup Language. The information about the at least one widget is stored in a local repository on the client computer. This information preferably includes data on the placement of the widget, size of the widget, and caption for the widget. This information generally does not include information selected from the group consisting of shape of the widget, style of the widget, and color of the widget.

Preferably, the viewer maintains state with the projector while the software application is executed by the client computer. The viewer transmits all user interaction with the graphical user interface to the projector over the Internet or an intranet. The graphical user interface for the software application appears like a native software application on the client computer.

In an additional embodiment, the projector is configured to define user access to the software application. The projector is further configured to track usage of the software application by each user and generate bills for usage of the software application in predetermined increments.

### BRIEF DESCRIPTION OF THE DRAWINGS

The present invention is better understood by a reading of the Detailed Description of the Preferred Embodiments along with a review of the drawings, in which:

FIG. 1 is a block diagram of the client-server system of the present invention.

FIG. 2 is block diagram of the client-server system of FIG. 1 including multiple client computers.

FIG. 3 is a flowchart of the process in which an interface for a software application is generated on a client computer in accordance with the present invention.

### DETAILED DESCRIPTION OF THE PREFERRED EMBODIMENTS

The illustrations and examples discussed in the following description are provided for the purpose of describing the preferred embodiments of the invention and are not intended to limit the invention thereto.

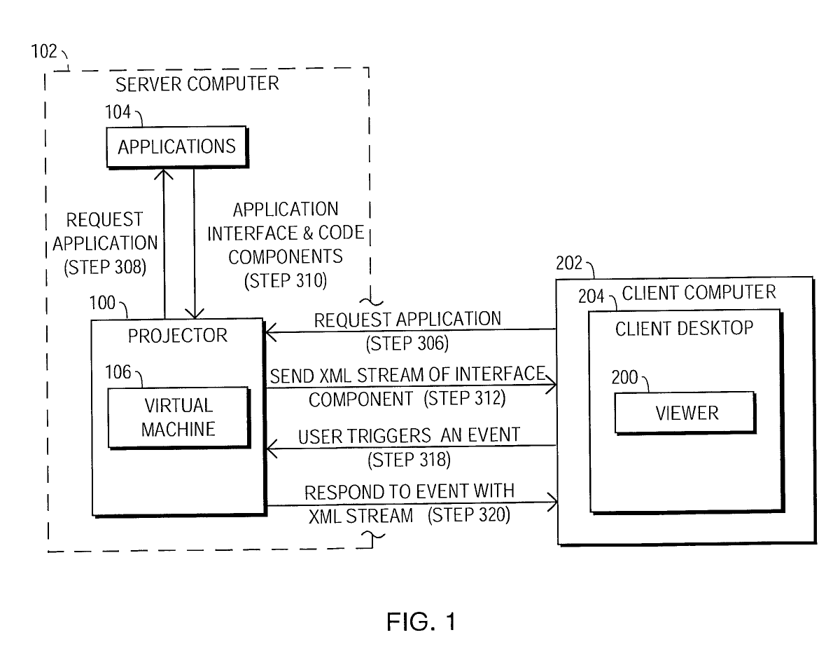

As shown in FIG. 1, the client-server system of the present invention generally consists of two main components, referred to herein as a projector 100 and a viewer 200.

### The Projector

The projector 100 component of the present invention is a software application server that runs on a server computer 102. The server computer 102 includes application storage 104 that stores the plurality of software applications that are published to the projector 100, as discussed below.

In general, all software application programming for the present invention is done using conventional language constructs in a fully integrated development environment. Thus, software developers that are familiar with Microsoft's Visual Basic®, Java, C/C++, and Perl, for example, are able to easily transition to writing applications in accordance with the system of the present invention.

The software developer creates a software application's graphical user interface (“GUI”) by visually laying out the application's windows and widgets (menus, buttons, scroll bars, etc.), and then tying handler code to widgets' events. Thus, each software application contains two separate components: interface definition and handling code.

Upon completion of a software application, the programmer “publishes” the application to the projector 100 to make the application accessible to the client computer 202. The process of “publishing” the software application is the process of storing the application in a storage medium on the server 102. When an application is published to the projector 100, the handler code is translated into special byte code on the fly; byte-code can be executed much faster than the original source code. At this time, any recognized programming errors are caught and reported to the software developer. If no errors are found, then byte-code and the interface definition are compiled and stored in application storage 104 as a single file. Also, any available code optimizing takes place during this step.

Publication of an application can be done from anywhere in the world, and once an application is “published” and placed in application storage 104, it is instantly available to any authorized client computer 202 on the network upon request. Thus, the software application does not have to be downloaded or installed on the client computer 202.

Also, when an application is published, all clients immediately have access to the latest version of the software. Thus, when the developer makes changes to an existing application or publishes an entirely new application, there is no need to send out software updates to clients or perform lengthy installations to the client computers. Rather, the users receive application updates instantly, unlike Java-based portal applications where the users must wait for the updated executable to be downloaded if changes are made to the application. Therefore, the present invention provides the system administrator with the ease of administration that comes with thin-client technology.

Due to the thin-client nature of the present system, only the user interface definition is actually sent to the client computer 202 when it requests to run an application. All code execution takes place inside a virtual machine 106 within the projector 100. The viewer 200 reports to the projector 100 any user interface events that the projector 100 is concerned about, and the viewer 200 updates the client's interface as needed, as discussed in detail further below.

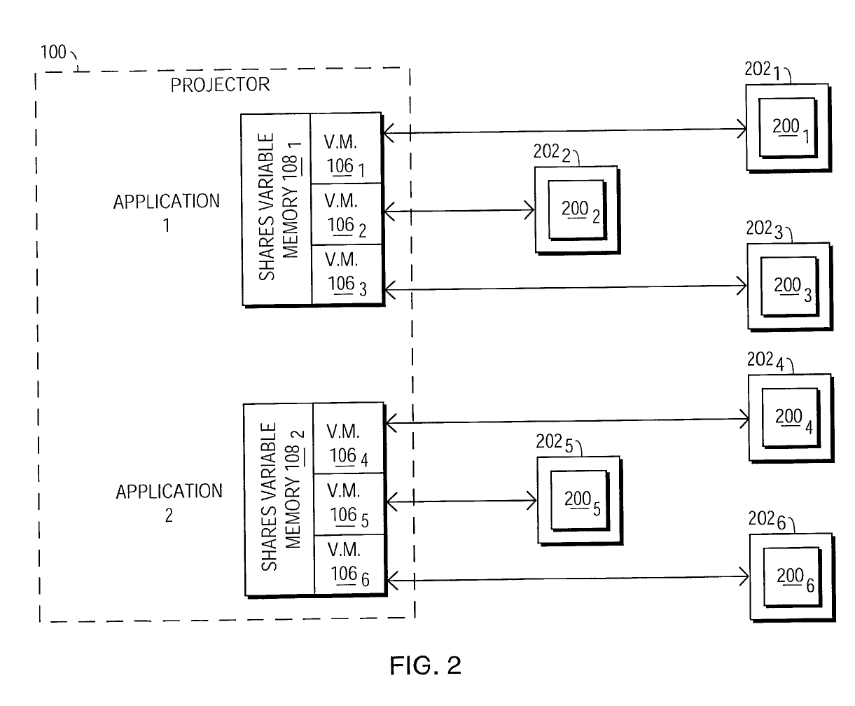

As shown in FIG. 2, a single projector 100 is capable of serving multiple client computers 202 and multiple applications at a time. Specifically, each client computer 202 connects to its own dedicated virtual machine 106 in the projector 100. Shared variable memory 108 may be provided for each set of virtual machines 106 accessing the same application so that, if necessary, the application developer can coordinate the activities of the various connected clients 202. It is also possible to treat each client computer 202 as an individual instead of part of a group. This means that any application developed using the server system of the present invention is automatically a multi-threaded, multi-user application without any special coding on the part of the developer.

The projector 100 may also be configured to operate as an administrative console in a corporate or application service provider (“ASP”) environment. For example, the projector 100 may be configured to enable a system administrator to control user access to published applications and resources. This may be achieved by setting up users and defining user access, such as which applications users are authorized to access and for how long. The projector 100 may be further configured to track application usage and enable the system administrator to bill the users in predetermined increments. For example, an ASP may bill a user for application usage on a per use basis or by the month, hour, or minute. Therefore, the present invention provides the necessary tools for an ASP to not only deliver high-quality applications over the Internet or an intranet, but to control user access and generate bills. In addition, the projector 100 may be set up to perform certain statistical functions, such as monitoring the status and quality of client computer connections 202. The forgoing administrative functions that may be performed by the projector 100 are not exhaustive. Rather, the projector 100 may be programmed to perform a plurality of administrative functions tailored to the system administrator's specific needs.

### The Viewer

The viewer 200 is a thin client application that connects to the projector 100 to provide the interface for the published software application at the client computer 202. The viewer 200 has a small footprint and is designed to be highly portable across a plurality of client operating systems, such as Microsoft's Windows® 95/98/NT/2000, Linux, personal digital assistants, and any other viable platforms. The viewer 200 is also designed to be small so that it can easily be retrieved from a standard web page and used without a lengthy download and install procedure.

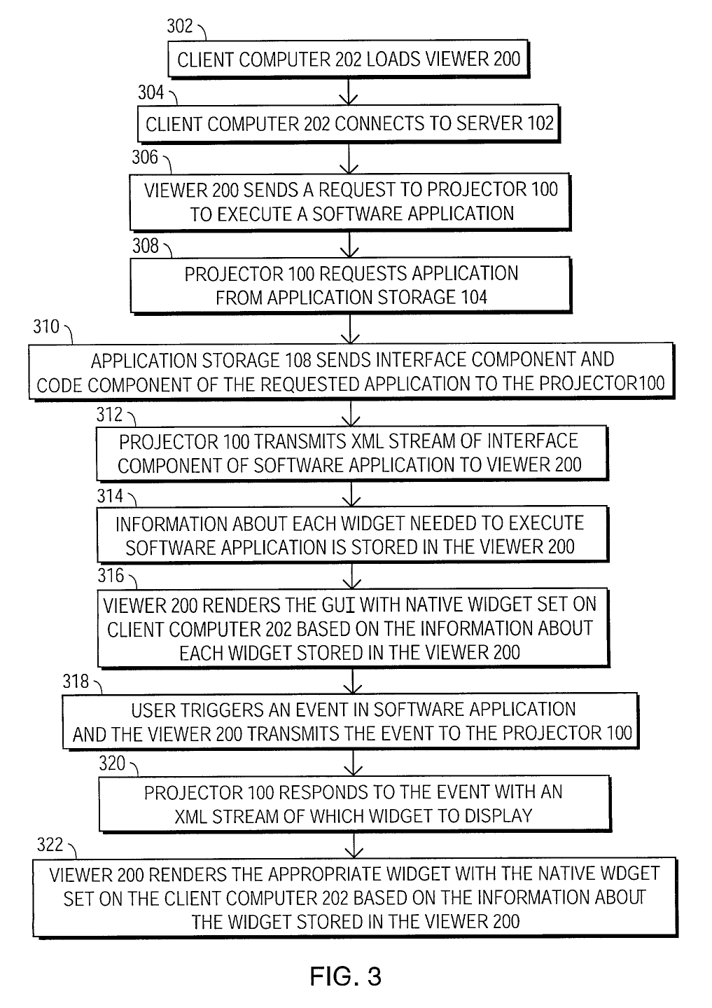

As shown in the flowchart of FIG. 3, once the user loads the viewer 200 on the client computer 202 (step 302), he/she may connect to the server 102 (step 304). The server 102 may be running on the user's local area network (“LAN”) or may be accessed through the Internet.

When the user wishes to access a published application, the viewer 200 sends a request to the projector 100 to execute the application (step 306). The projector 100 then sends a request to application storage 104 to retrieve the application (step 308). The application storage 104 responds to the projector 100 with the interface component and the code component of the application, as discussed above (step 310). The projector 100 then responds to the viewer 200 with the interface component of the software application in a descriptive language such as Extensible Markup Language (“XML”) (step 312). XML is generally more flexible than the HTML format used by browser-based thin clients programs. The XML stream includes information about each widget that is needed by the client computer 202 to execute the software application. For example, the XML stream may include a name for each widget, directions on the size and placement of each widget, and any captions provided on each widget. This information is stored in the viewer 200 in the local repository of the interface on the client computer 202 (step 314). The XML stream generally does not include information about the appearance of the widgets for the software application, such as their shape and style, because this information is determined by the client computer's 202 operating system. Specifically, the native widget set of the client computer's 202 operating system is used to draw the interface, or render the GUI, so an application published in accordance with the present system looks and feels just like a native desktop application to the user (step 316). For example, the XML stream from the projector 100 may include instructions that button “X” should be placed on the GUI in a certain position. The native widget set on the client computer 202 dictates the appearance of the button, such as its style, shape, and color, and it is positioned in accordance with the information about the widget provided the projector 100 in the XML stream. Thus, the user is unable to discern whether he/she is accessing a software application published in accordance with the present invention or a software application that has been installed locally on the client computer 202.

The viewer 200 is responsible for transmitting all user interaction with the GUI to the server 102. Specifically, whenever the user initiates an event while accessing an application by clicking on a button or pressing “Enter,” for example, the viewer 200 sends the event to the projector 100 (step 318). The projector 100 then handles the event and directs the viewer 200 on how to respond to the event. This response may inform the viewer 200 to update the GUI or simply acknowledge that the event occurred. If the response informs the viewer 200 to update the GUI, the projector 100 may, for example, simply tell the viewer 200 which widget to display (step 320). The projector 100 does not have to retransfer to the viewer 200 the information about the widget because information about all of the widgets needed for the software application is already stored locally on the client computer 202, as discussed above and indicated in step 314 of FIG. 3. The viewer 200 simply renders the appropriate widget with the native widget set of the client computer's 202 operating system (step 322). Therefore, any required processing is performed on the server 102 and the client computer 202 is informed of the results only if the user needs to know, making the viewer 200 a thin client program.

This process of generating an interface for a software application at the client computer 202 is advantageous as compared to browser-based thin clients because it does not require a web browser. Rather, the viewer 200 runs directly and locally on the client computer 202 to provide the user with an easy-to-use, familiar environment. Instead of the browser being the portal, the client computer's 202 desktop becomes the portal. Further, it takes less time for developers to create software applications in accordance with the present invention because they do not have to bother with entering data into web pages in HTML, JavaScript, VBScript, ASP, Java, etc. Thus, the present invention combines the ease of design found in most modem rapid application development (“RAD”) tools, with the speed and power of thin-client design to produce an application capable of running over the Internet on multiple client platforms.

In addition, unlike browser-based thin clients, the viewer 200 of the present invention is not stateless, meaning that the server 102 does not have to be refreshed each time a new event occurs. Rather, the viewer 200 of the present invention maintains state by maintaining a lasting connection with the projector 100 on the server 102, similar to custom client binaries. As a result of maintaining a lasting connection and not having to continuously recreate an entire page, the viewer 200 of the present invention operates faster than browser-based thin clients.

The present invention is also advantageous as compared to custom client binaries because it sends updates to the server 102 only when the user performs an event by clicking on a button or pressing “Enter,” for example. Custom client binaries, on the other hand, generate an open slate bitmap on the client computer so that each time the user moves the mouse or the cursor on the bitmap, an update is sent to the server. This makes custom client binaries extremely slow. Further, custom client binaries let the server draw the bitmap on the client computer. Thus, the user sees, and feels like he/she is using, a server computer rather than a native desktop application. The present invention, on the other hand, enables the client computer 202 to render the appearance of the server's 102 response.

In view of the forgoing, the system of the present invention bridges the gap between traditional desktop applications, custom client binary programs, and web-based applications. Working together, the projector 100 and viewer 200 give the user the illusion of operating a traditional desktop application when, in reality, the user is running a thin-client. The application's windows, buttons, text boxes, menus, etc. look and feel just like those of other applications that are run on the client desktop, no matter what desktop operating system is running on the client computer 202. This gives the user a comfortable, familiar environment from which to work while providing all of the benefits of remote application execution.

Certain modifications and improvements will occur to those skilled in the art upon a reading of the forgoing description. All such modifications and improvements of the present invention have been deleted herein for the sake of conciseness and readability but are properly within the scope of the following claims.

What is claimed is:

1. A system for generating a graphical user interface for a software application in a client-server environment comprising:
a projector that runs on a server computer, said projector being configured to process at least one software application, the at least one software application having an interface component and a code component; and
at least one viewer, said at least one viewer running on at least one client computer and being configured to generate a graphical user interface for the at least one software application on the at least one client computer;
wherein said projector provides said at least one viewer with the interface component of the at least one software application, the interface component including information about at least one widget of the at least one software application;
wherein the information about the at least one widget is stored on the at least one client computer; and
wherein said at least one viewer renders the graphical user interface on the at least one client computer with a native widget of the at least one client computer based on the information about the at least one widget stored on the at least one client computer.

2. The system of claim 1 wherein during execution of the at least one software application by the at least one client computer, said projector directs said at least one viewer to update the graphical user interface with the native widget set of the at least one client computer based on the information about the at least one widget stored on the at least one client computer.

3. The system of claim 1 wherein the code component of the at least one software application is processed in said projector during execution of the at least one software application by the at least one client computer.

4. The system of claim 3 wherein processing of the code component of the at least one software application is performed in at least one virtual machine within said projector.

5. The system of claim 4 wherein a single client computer corresponds with a single virtual machine.

6. The system of claim 4 wherein said projector comprises a separate shared variable memory for each set of virtual machines accessing a single software application.

7. The system of claim 1 further comprising at least one additional viewer and at least one additional client computer, each said viewer running on a separate client computer.

8. The system of claim 1 wherein said projector is further configured to process at least one additional software application, the at least one additional software application having an interface component and a code component.

9. The system of claim 1 wherein said projector is a software application server.

10. The system of claim 1 wherein the server computer comprises application storage for storing the at least one software application.

11. The system of claim 10 wherein the interface component and the code component of the at least one software application are stored as a single file in said application storage.

12. The system of claim 1 wherein the at least one software application is published on said projector when the interface component and the code component of the at least one software application are stored in the server computer.

13. The system of claim 12 wherein the interface component includes handler code that is translated to byte code when the at least one software application is published on said projector.

14. The system of claim 12 wherein the at least one software application is accessible to the at least one client computer once the at least one software application is published on said projector.

15. The system of claim 1 wherein said at least one viewer is a thin client program.

16. The system of claim 1 wherein said at least one viewer is portable across a plurality of operating systems, including operating systems selected from the group consisting of Microsoft's Windows and Linux.

17. The system of claim 1 wherein said projector provides said at least one viewer with the interface component of the at least one software application in a descriptive language.

18. The system of claim 17 wherein the descriptive language is Extensible Markup Language.

19. The system of claim 1 wherein the information about the at least one widget is stored in a local repository on the at least one client computer.

20. The system of claim 1 wherein the information about the at least one widget includes information selected from the group consisting of placement of the widget, size of the widget, and caption for the widget.

21. The system of claim 1 wherein the information about the at least one widget does not include information selected from the group consisting of shape of the widget, style of the widget, and color of the widget.

22. The system of claim 1 wherein said at least one viewer transmits all user interaction with the graphical user interface to said projector.

23. The system of claim 1 wherein the at least one client computer connects to server computer via the Internet or an intranet.

24. The system of claim 1 wherein the graphical user interface for the at least one software application appears like a native software application on the at least one client computer.

25. The system of claim 1 wherein said at least one viewer maintains state with the said projector while the at least one software application is executed by the at least one client computer.

26. The system of claim 1 wherein said projector is configured to define user access to the at least one software application.

27. The system of claim 26 wherein said projector is configured to track usage of the at least one software application by each user.

28. The system of claim 27 wherein said projector is configured to generate bills for usage of the at least one software application in predetermined increments.

29. A method of generating a graphical user interface for a software application in a client server environment comprising the steps of:
providing a client computer with access to a software application, the software application having an interface component and a code component and being stored on a server computer;
transmitting to the client computer only the interface component of the software application, the interface component including information about at least one widget needed to execute the software application;
storing the information about the at least one widget on the client computer; and
rendering a graphical user interface for the software application on the client computer with a native widget set of the client computer based on the information about the at least one widget stored on the client computer.

30. The method of claim 29 further comprising the step of updating the graphical user interface on the client computer during execution of the software application by the client computer with the native widget set of the client computer based on the information about the at least one widget stored on the client computer.

31. The method of claim 29 further comprising the step of processing the code component of the software application in the server during execution of the software application by the client computer.

32. The method of claim 29 further comprising the step of maintaining state between the client computer and the server computer during execution of the software application by the client computer.

33. A computer readable media comprising software for generating a graphical user interface for a software application in a client-server environment, the software being configured to instruct a computer to:
provide a client computer with access to a software application, the software application having an interface component and a code component and being stored on a server computer;
transmit to the client computer the interface component of the software application, the interface component including information about at least one widget needed to execute the software application;
store the information about the at least one widget on the client computer; and
render a graphical user interface for the software application on the client computer with a native widget set of the client computer based on the information about the at least one widget stored on the client computer.

34. The computer readable media of claim 33 wherein the software is configured to further instruct a computer to update the graphical user interface on the client computer during execution of the software application by the client computer with the native widget set of the client computer based on the information about the at least one widget stored on the client computer.

35. The computer readable media of claim 33 wherein the software is configured to further instruct a computer to process the code component of the software application in the server during execution of the software application by the client computer.

36. The computer readable media of claim 33 wherein the software is configured to further instruct a computer to transmit user interaction with the graphical user interface from the client computer to the server computer.

37. The computer readable media of claim 33 wherein the software is configured to further instruct a computer to maintain state between the client computer and the server computer during execution of the software application by the client computer.

38. A computer readable media comprising software for generating a graphical user interface for a software application in a client-server environment, the software being configured to instruct a computer to:
store a software application having an interface component and a code component;
transmit the interface component of the software application to the client computer, the interface component including about at least one widget of the software application; and
instruct the client computer to render the graphical user interface with a native widget set of the client computer based on the information about the at least one widget of the software application.

39. A computer readable media comprising software for generating a graphical user interface for a software application in a client-server environment, the software being configured to instruct a computer to:
request a server computer to execute a software application stored on the server, the software application having an interface component and a code component;
retrieve from the server the interface component of the software application, the interface component including information about at least one widget of the software application;
store the information about the at least one widget of the software application in a local repository; and
render a graphical user interface for the software application with a native widget set based on the information about the at least one widget of the software application from the server.

40. The computer readable media of claim 39 wherein the software is configured to further instruct a computer to:
transmit user interaction with the graphical user interface to the server computer;
receive a response to the user interaction from the server computer; and
update the graphical user interface with the native widget set based on the response from the server computer and the information about the at least one widget of the software application.
